(19) United States
(12) Patent Application Publication
(10) Pub. No.: US 2007/0088609 A1
(43) Pub. Date: Apr. 19, 2007

(54) Optimizer For Selecting Supplemental Content Based on Content Productivity of a Document

(75) Inventors: William M. Reller, Beaux Arts, WA (US); Sean Patrick Nolan, (US); Michael Libes, Bainbridge Island, WA (US); John Crim, Seattle, WA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Medio Systems, Inc., Seattle, WA (US)

(21) Appl. No.: 11/561,832

(22) Filed: Nov. 20, 2006

Related U.S. Application Data
(63) Continuation-in-part of application No. 10/694,643, filed on Oct. 27, 2003.
(60) Provisional application No. 60/421,507, filed on Oct. 25, 2002.

(51) Int. Cl. G06Q 30/00

(52) U.S. Cl. 705/14

(57) ABSTRACT

Content is selected for display at a client computer communicating over a computer network by determining a relevance score for content of a document at a server computer for delivery to a requesting client computer, determining at least one valuation for the content from each of two or more supplemental content sources, generating a productivity score for each of the supplemental content sources in accordance with the corresponding content valuation for the supplemental content source, selecting the supplemental content source having the greatest productivity score, and serving the document and supplemental content from the selected supplemental content source for delivery to the requesting client computer.

### CROSS-REFERENCE TO RELATED APPLICATIONS

This application is a continuation-in-part application and claims priority to U.S. patent application Ser. No. 10/694,643 filed Oct. 27, 2003 entitled Selecting Ads for a Web Page Based on Keywords Located on the Web Page, which claims priority from U.S. Provisional Application No. 60/421,507 filed Oct. 25, 2002 entitled Selecting Ads for a Web Page Based on Keywords Located on the Web Page. The disclosures of both these applications is incorporated herein by reference.

### BACKGROUND

The process of purchasing and placing advertisements online (e.g. at the World Wide Web and other Internet-based media) generally mirrors the process used for placing advertisements with conventional television, radio, and print media. The conventional media placement flow begins with advertisers, who buy placement opportunities directly with publishers or indirectly through advertising networks representing groups of publishers. The advertisers may purchase the placement opportunities themselves or may work through advertising agencies. This simple flow has worked well for placing advertisements with television, radio, and print media, but it fails to use the bi-directional nature of the Internet and the real-time automation available via the computers attached to the Internet.

For example, with most Web site advertising, advertisements are provided by an advertising placement company into ad slots specified by the Web site owner. The Web site owner may require that no ads be provided for a business that competes with the Web site owner, but there is little other guidance for the ads that are placed. The advertising placement company can read each page on a site and try to select ads to appear with that page that are related to the subject matter of the page, but this is usually considered too labor intensive.

Placement of advertising and selection of competing advertisers for placement of advertising content could be made more efficient and achieve better results if the interactive, real-time nature of Internet communications could be exploited. Thus, there is a need for a mechanism that supports placement of advertising in real time using Internet communications. The present invention satisfies this need.

### SUMMARY

In accordance with the invention, content is selected for display at a user client device communicating over a network. The selection of content involves a document at a server computer that is requested by a client device, wherein at least one valuation is determined for supplemental content that will be supplied along with the requested document, such that the supplemental content is supplied from each of two or more supplemental content sources. A productivity score is generated for each of the supplemental content sources in accordance with the corresponding content valuation for the supplemental content source, the supplemental content source having the greatest productivity score is selected, and the document and supplemental content from the selected supplemental content source are provided for delivery to the requesting client device. The network over which communications between the server and client devices occurs can comprise an extended network, such as the Internet. The supplemental content can comprise material such as advertising or related information likely to be of interest to the user at the requesting client device. The supplemental content sources can comprise advertisers or brokers or the like. In this way, placement of supplemental content such as advertising, and selection of competing advertisers for placement of such supplemental content along with requested content, can be more efficiently performed and better results can be obtained by exploiting the interactive, real-time nature of Internet communications.

In one embodiment, the document requested by a client device comprises a Web page that is obtained from a network server device. In another aspect, the document content comprises keywords of the Web page, and the valuation comprises keyword bid values from the supplemental content sources. The supplemental content sources can be advertisers who wish to place ads (the supplemental content) for delivery with a Web page. The bid values can be received from the supplemental content sources in response to a request for bids issued after a request for the Web page is received from the requesting client device.

Other features and advantages of the present invention should be apparent from the following description of the preferred embodiments, which illustrate, by way of example, the principles of the invention.

### BRIEF DESCRIPTION OF THE DRAWINGS

FIG. 1 shows a dictionary tree for a set of word phrases.

FIG. 2 shows the cost per click values of different words from multiple ad sources.

FIG. 3 shows a decision matrix for selecting among ads to be placed.

FIG. 4 shows how ad types may be selected based on partner requirements, keyword relevance and keyword value.

FIG. 5A, 5B depicts the conventional process for placing advertising.

FIG. 6 shows the process of placing advertising in accordance with the invention.

FIG. 7 is a flowchart of the process illustrated in FIG. 6 as implemented by a computer system constructed in accordance with the present invention.

FIG. 8 illustrates an advertisement placement opportunity bid.

FIG. 9A, 9B show the process of an advertisement bid response.

FIG. 10 is an illustration of the Adlet processing in accordance with the invention.

FIG. 11A, 11B, 11C illustrates Adlet architectures.

FIG. 12 is a block diagram of a computer system constructed in accordance with the invention.

### DETAILED DESCRIPTION

The following detailed description and the figures illustrate specific exemplary embodiments by which the invention may be practiced. Other embodiments may be utilized and other changes may be made without departing from the spirit or scope of the present invention. The following detailed description is therefore not to be taken in a limiting sense, and the scope of the present invention is defined by the stated claims.

Implementations of the invention support selection of supplemental content for display at a client device communicating over a computer network. The selection of supplemental content is achieved by determining a relevance score for content of a document at a server computer for delivery to a requesting client device, determining at least one valuation for the content from each of two or more supplemental content sources, generating a productivity score for each of the supplemental content sources in accordance with the corresponding content valuation for the supplemental content source, selecting the supplemental content source having the greatest productivity score, and serving the document and supplemental content from the selected supplemental content source for delivery to the requesting client device. In one embodiment, the document requested by the client device comprises a Web page. In another aspect, the document content comprises keywords of the Web page, and the valuation comprises keyword bid values from the supplemental content sources. The supplemental content sources can be advertisers who wish to place ads (the supplemental content) for delivery with a Web page. The supplemental content to be delivered along with the requested document can comprise material such as product recommendations, or news stories, links to related stories and related products, related news stories, or other relevant information. In this way, the supplemental content acts as a “garnish” to the requested document. The bid values can be received from the supplemental content sources in response to a request for bids issued after a request for the Web page from the requesting client device. Thus, supplemental content such as advertising can be placed, and competing advertisers or other sources of material for placement of such supplemental content can be selected, by exploiting the interactive, real-time nature of Internet communications.

In one embodiment, an automated computer system evaluates the content on a Web page and then delivers, for display with the page, targeted ads that relate to content on the Web page. The content is evaluated by identifying keywords used on the page, as specified in the content (source) code typically specified in html. Evaluation of the content gives each keyword a weight, and uses the weighted keywords as an indicator of content for selection of targeted ads to be shown with the page.

In a second, related aspect, keywords that were entered by a user into a search engine to find the page (the requested content) are tracked and then still more targeted ads for that particular user are delivered, based on the keywords entered by the user to find the page.

Another embodiment of the system applies both a relevance algorithm and a revenue algorithm to the content on a Web page and then delivers the most productive advertisements from a single source or a variety of advertising sources. By evaluating the content on a Web page and selecting the most productive advertisements (relative to that content) to deliver to the end user, media companies can generate increased revenue and merchants can more easily find customers.

One embodiment of the invention implements the following steps:

1. First, a Web page is evaluated to understand its context. The phrases that are identified in the evaluation are considered to be keywords. For example, an article about the Seattle Seahawks might be evaluated to find “Seattle Seahawks” to be the most relevant keyword and “football” to be second most relevant.

2. If more than one keyword is found to be relevant, or more than one advertisement is selected by a keyword, the keywords and advertisements are ranked based on which advertisements are going to generate the most revenue. Factors that influence this are its overall relevance (relevance score) to the page, revenue per impression, revenue per click and actual or expected click rates. The most valuable ad can be selected from among multiple ad partners with ads. So for example, if Google is willing to pay $0.40 per click for ads associated with “Palm Pilot”, and if Overture is willing to pay $0.60 per click for ads associated with “Palm Pilot”, then the Overture ads might be selected, because they are willing to pay more per click. On the other hand, the lower pay-per-click ad (in this example, the Google ad) might be selected if other factors are present, such as a greater click-through rate or a greater available ad network or the like that can indicate a greater ad value.

3. Then the ad is served.

In one aspect of the invention, a programming module referred to as an advertising marketplace optimizer (also referred to as an “ad optimizer”) manages communications between sources of supplemental content (such as advertisers) and publishers who make available the requested documents that are delivered along with the supplemental content.

In accordance with another aspect of the invention, the ad optimizer comprises programming modules referred to as “Optimizer” and “Adlet” that carry out processing by managing communications among the various entities over the Internet (by the Optimizer) and by selecting the best bid for supplemental content, such as advertising, from among competing sources of the supplemental content (by the Adlet). These programming modules are described in greater detail below.

The client devices can comprise a variety of processing devices that can communicate with computer networks. These devices can include, for example, laptop computers, desktop computers, smart phones, PDAs, and the like. The network communications can take place over a wireless connection or over fixed connections.

The invention encompasses computer methods, computer programs on program carriers (such as disks or signals on computer networks) that, when run on a computer, implement the method, and computer systems with such programs installed for implementing the method. The various embodiments of the invention may be implemented as a sequence of computer implemented steps or program modules organized in any of many possible configurations. The implementation is a matter of choice dependent on the performance requirements of the computing system implementing the invention.

For explanation, an embodiment of the invented method may be divided into three steps with an optional fourth step. The practical application of these steps can be seamlessly integrated or separated into independent components.

Step 1. Evaluate the content on a page for keyword relevance. (Keyword lists may be generated internally and/or provided by advertisers and/or advertising partners.) This evaluation applies an algorithm that considers both the number of occurrences and the location of the occurrences of any given keyword (or words or phrases associated with a given keyword) and, using this information, gives each keyword on the page a “Relevance Score.” This algorithm is explained in detail below. From this analysis, a media company could choose to show a list of relevant keywords as “related searches” that will link to search results. Alternatively, the information could be used to pull advertisements as detailed below.

Step 2. Query a group of advertising partners (or a single advertising source) to learn the revenue generation potential of each keyword (“Cost Per Click” or “Cost Per Impression”) from each partner. Apply this data to the Relevance Score to determine a “Productivity Score”. Overtime, click-thru rates of certain advertisements and keywords may influence the potential revenue production of keywords which, in turn, may influence the Productivity Scores.

Some of the “advertising sources” may be developed by enabling media sites with ability to allow their own advertisers/viewers to bid for ad placement using ad bidding technology. Advertisers and/or media partners will determine if ads loaded thru this system will be limited to the media site where the ad was originated or distributed across the entire Company network.

Step 3. Productivity Score (and Relevance Score and Cost Per Click or Cost Per Impression) will be used to determine the advertiser and the type of advertisement to display (banner, button, pop-up, etc.) with the page.

For example, consider a Web site run by a news organization such as the Seattle Times. They run an article about The Seahawks and, if they have advertising on the Web page, it is non-targeted. The invented system would place ads for Seahawk Tickets, Seahawk Memorabilia and Football related merchandise. The system does this by reading the content on a page and comparing that content to a long list of keywords. The system applies an algorithm that considers the number of occurrences and location of the different keywords on the page. The system also can consider the number of words in a keyword (keyword phrase), and the potential value derived from showing ads related to a particular keyword. In this way, the system can serve advertisements that are much more likely to be of interest to the reader of the page—therefore delivering superior value to the advertiser and the media sites.

Step 4. As an optional fourth step, the system can be designed to also consider the apparent interests of a particular user if the user came to the page from a search based on search words entered by the user. For example, the Seattle Times Web site includes a search feature. Each article can be found as a result of many different searches with different words, all of which will lead to the same article. However, a user that comes to a particular article from a search for “sports events in Seattle” might be shown different ads based on the words used in that search phrase than a user that comes to the article from a search on “NFL”. The words used by the user in the search are used to further adjust the selection of ads to show to that user by consulting the same long keyword list.

Where the search engine is a part of the same site as the Web pages that are found from the search, implementation of this fourth step is straight forward. To implement this fourth step with search engines that are not part of the site, a parameter consisting of the search words entered by the user to find the hyperlink must be passed from the search engine site to the page that is specified by the hyperlink. This is preferably done by the search engine site adding the search words as a parameter at the end of the hyperlink. Software on the host computer for each Web page is modified to interpret this parameter. Alternatively, the parameter may be passed via a cookie placed on the user's computer. By using cookies, words used in prior searches that led to the same page can also be passed as additional parameters. Additionally, words used in prior searches can influence the advertisement selection of future pages regardless of the content on the page. So a user who searches for “cell phones” could be determined to be interested in cell phones and shown ads related to cell phones even when they are reading a page related to President Bush.

Determining Relevance Score for each Phrase on a Page of a Web Site

The system receives as input all the words of a Web site page and organizes them into phrases as is well known in search technology. Documents are composed of, or normalized into, text fetched using a network or other means and parsed into a stream of words. Then, given this set of phrases from a source document (Web page), the system quickly returns a list of phrases that appear in the document, ordered descending by a measure of relevance. For example, a measure of relevance for each word might be based on location in the page according to the following ruleset as illustrated by Table 1:

TABLE 1

| | |
|---|---|
| Location of keyword in body | Weights |

| | | |
|---|---|---|
| 01-30 | words | 10 |
| 31-100 | words | 7 |
| 101-500 | words | 2 |
| 501-1000 | words | 2 |

Phrases consist of one or more keywords. Using the weights stated above, the system computes a maximum bid (“overall relevance value”) for each phrase. The phrases of the page are arranged on system startup into a tree structure designed for efficient searches.

Data Structures for Determining Relevance of Phrases

Three data structures are illustrated in the tables below for determining relevance of phrases in the content. The data structures are identified below in Table 2 as Phrase, PhraseMatchNode, and KeyTreeNode.

TABLE 2
DATA STRUCTURES FOR DETERMINING
RELEVANCE OF PHRASES
Phrase

| | |
|---|---|
| Phrase ID | Integer |
| Keyword Count | Integer |
| Keywords | String, whitespace separates |
| | keywords |

PhraseMatchNode (associates state data with a phrase)

| | |
|---|---|
| Phrase | Pointer to phrase |
| Match Info | Bitmask, purpose dep[ends on |
| | context |
| Relevance | Integer |

KeyTreeNode (represents component keywords that make up phrases)

| | |
|---|---|
| Keyword | Implicit string based on position |
| | within the dictionary tree, not |
| | stored within node |
| Phrase/Position List | Array of PhraseMatchNode |
| | pointers for phrases that contain |
| | this keyword, sorted by Phrase ID. |
| | Match Info in the PMN is a |
| | bitmask representing the |
| | position(s) of this keyword in the |
| | phrase. |
| Child KTN List | Array of KeyTreeNode pointers |
| | for children of this node. 256 |
| | elements, addressed directly by |
| | character value. Mechanisms for |
| | reducing the sparseness of this |
| | array are in place. |

Dictionary Tree

During startup, each phrase is broken down into its component keywords. Regardless of how many times keywords are represented in phrases, each is represented only once in the system by a unique KeyTreeNode (“KTN”). The keyword that a KTN represents is not stored in the KTN itself; it is implied by the location of the KTN in the dictionary tree.

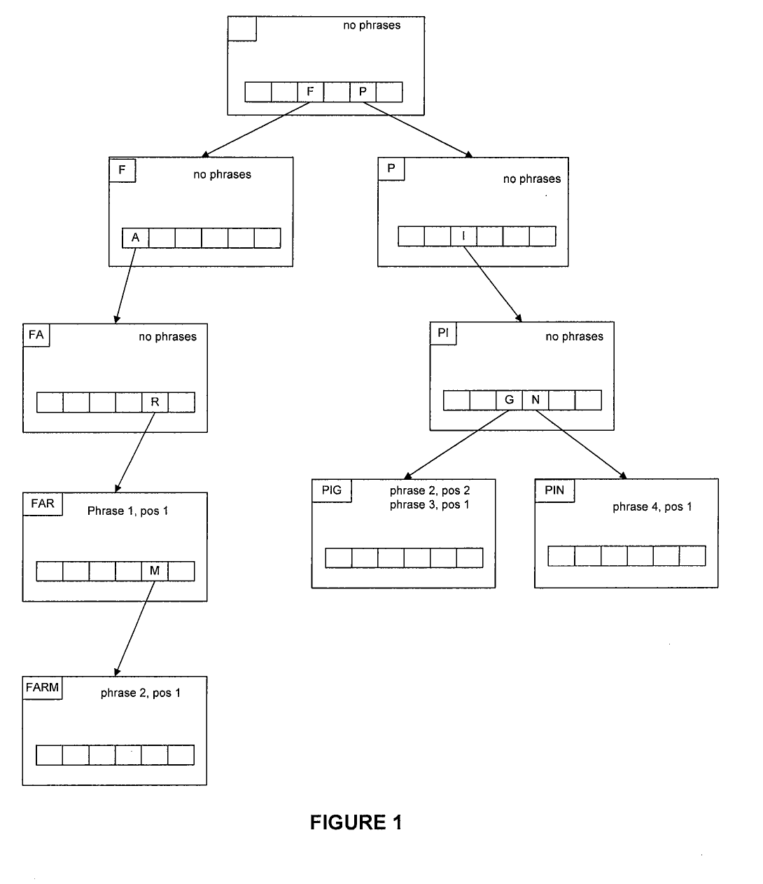

KTNs are loaded into a dictionary tree in which each node represents a letter in a particular ordinal position in the keyword. Also associated with the KTN is an array of Phrases that contain the implied keyword. It is easiest to make sense of this using a diagram as shown in FIG. 1. Assume a system with the following four phrases:

Phrase ID 1: FAR

Phrase ID 2: FARM PIG

Phrase ID 3: PIG

Phrase ID 4: PIN

Note that all words are normalized for punctuation and converted to lower-case. The dictionary tree for this setup will have the structure shown in FIG. 1.

Note that for each phrase/keyword pair (the Phrase Match Node array, “PMN”) position information is stored as a bitmask: position 1=0x00000001, position 3=0x00000004, and so on. If a keyword appears in more than one position in a phrase, multiple bits will be set. For example, if a phrase is “big big fish”, in the PMN for “big” the bitmask will be 0x00000003 (first and second bits set).

Live editing of the tree is supported. A combination of CPhrase refcounts and KTN-level locking allows for a thread-safe interface to the tree.

Matching Process

Two interim collections of PhraseMatchNodes (“PMNs”) facilitate the matching process. The “hit array” contains phrases that have matched the document. A phrase will only be represented in the hit array once, but relevance from multiple matches will accumulate in that PMN. The hit array is sorted by phrase id for easy lookup.

The “candidate list” contains phrases that match “so far”. That is, some subset of their keywords have matched but not all. As each word from the document is examined, PMNs are added to or removed from the candidate list as appropriate.

The following pseudocode in Table 3 describes the matching process:

TABLE 3
HitArray [symbol] empty
CandidateList [symbol] empty
For Each keyword in document

ktnKeyword [symbol] Lookup keyword in the dictionary tree
If ktnKeyword != Null

// process existing candidates
For Each pmnCandidate in CandidateList

pmnKeyword [symbol] Lookup pmnCandidate.PhraseID In
ktnKeyword PMN List
If pmnKeyword != Null

// this keyword is in the candidate phrase
Shift pmnCandidate.MatchInfo left by 1
If (pmnKeyword.MatchInfo &
pmnCandidate.MatchInfo)

// the keyword is in the correct position
If we've matched the entire phrase

Move pmnCandidale.phrase to HitArray

Else

Leave pmnCandidate in Candidate List

Else

Remove pnmCandidate from CandidateList

Else

Remove pmnCandidate from CandidateList

// add new phrases that begin with this keyword to the
candidate list
For Each pmnKeyword In ktnKeyword PMN List

If pmnKeyword.MatchInfo has bit 1 set

If pmnKeyword.Phrase.KeywordCount = 1

Add pmnKeyword.Phrase directly to HitArray

Else

Add new pmnCandidate for this phrase to
CandidateList

Sort the hit array by relevance and return

Expanding the Model for AND and OR Matching

The above described bitmask-matching model also lends itself well to AND and OR keyword matches. In both cases, a “target” bitmask is maintained with the phrase, in which the rightmost KeywordCount bits are set. For AND matches, each position PMN match info is logically ORed with found positions; when the PMN match info is equal to the target bitmask all terms have matched. Note that in this case candidates remain in the candidate list even when subsequent keywords did not match, unlike exact matching. OR matches are even simpler in that every phrase that matches a keyword is automatically added to the hit array.

Base Keyword Relevance

As each keyword is parsed out of the document, it is assigned a base “relevance” score. This score is derived from a named ruleset, of which there is always at least one in a running instance of the system. Rulesets can be added or removed from the system during runtime using a Web services interface.

By default, the default ruleset named auto is used to generate relevance scores. If there is a tail-match between any ruleset name and the host portion of the document URL, that is used instead. For example, if a document is fetched from host “www.foo.com” and a ruleset named “foo.com” exists, it will be used. Finally, if the engine encounters a tag of the format <tstags-NAME>, the system will search for a ruleset named NAME and use it if found. This manual directive will override any prior ruleset selection. Rulesets may also be customized based on the host name of the system publishing the content, providing the best interpretation of each unique document format.

Rulesets are specified as XML fragments such as the XML fragment illustrated in Table 4 below.

TABLE 4

<ruleset name=“auto”>

<overrides>

<override name=“title” weight=“10”/>
<override name=“h1” weight=“10”/>
<override name=“h2” weight=“8”/>
<override name=“script” weight=“0”/>
<override name=“style” weight=“0”/>

</overrides>

<body tag=“body”>
<range maxwords=“100” weight=“7”/>
<range maxwords=“1000” weight=“3”/>
<range maxwords=“1500” weight=“1”/>

</body>

</ruleset>

By default, the system will examine as keywords only words that appear in the logical body of the document. What constitutes the logical body is defined by the body section of the ruleset. The tag attribute on the body tag indicates the tag that surrounds body content. Normally this is the standard HTML “body” tag. However, this is an imperfect model because the “body” of an HTML document contains navigation and other interface components, menu text, stock headers and footers, and so on that should not be considered as part of the unique content of the document. The system overcomes this by allowing the content publisher to specify what tag surrounds the logical body. This can be a new tag such as <ts-body> created specifically for the system, or it may be another tag already in place.

Keywords within the logical body are broken down by the system into ranges based on ordinal position. The range tags specify what relevance (i.e., weight) should be given to keywords within each range. Generally, words closer to the beginning of the document are given more weight as they are typically the topic sentence and paragraph of an article. After the largest range has been processed (1500 words in the sample ruleset above), parsing is terminated.

Overrides make up the remainder of a ruleset. Each override specifies a tag within which keywords are given an absolute weight, regardless of their position in the document. In the sample ruleset, for example, anywhere in the document that a “title” tag is found, the words within it will be given a weight of 10.

It should be noted that the system also allows the specification of attribute name/value pairs in ruleset definitions. This is necessary to do a good job of ruleset definition for many existing sites.

Aggregated Relevance

The relevance scores for each keyword are summed during the lifetime of the match process and eventually collected in the match node for each hit. So, assuming (1) we are using the sample ruleset above, (2) there is a query for “big dog” in the system, and (3) that phrase appears twice in the document body, once in the title and once between the 110th and 1,000th words in the body, relevance would be computed as listed in Table 5 below:

TABLE 5

| | |
|---|---|
| “big” found in title | 10 |
| “dog” found in title | 10 |
| “big” found in 100-1000 range | 3 |
| “dog” found in 100-1000 range | 3 |
| Aggregated Relevance | 26 |

This algorithm selects for phrase length, frequency in the document, and positions in the document. After performing a descending sort by aggregated relevance, we have identified the “best” phrase matches for the document.

At this point financial and productivity rules can be applied to select the best advertisements based on the phrase matches.

Determining Productivity Score for Each Phrase on a Page of a Web Site

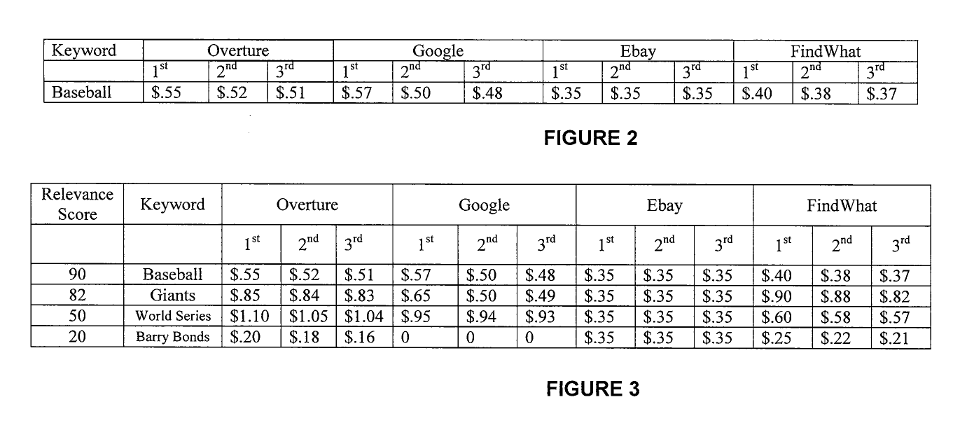

FIG. 2 shows the Cost Per Click (“CPC”) values of different words from multiple ad sources. In this example, each ad source is shown to have three advertisements that match each word. In practice, each ad source could have a large number of advertisers willing to buy ads triggered by specific keywords, and those ads could be sold on a CPC basis or on a Cost Per Impression (“CPM”) basis. Additionally, while four ad sources are being considered in this sample table, there is no limit to the potential list of ad sources that the system can utilize-yellow page publishers, classified ad publishers, LookSmart, Ah-Ha, Ad Networks, large advertisers (i.e. Amazon) and others are all suitable advertising content providers.

With respect to FIG. 3, assume that the only keyword match on a page is “Baseball” and that a Web site owner (“distribution partner”) wants three ads shown on their page. Under this situation, as indicated by the price numbers in the table in FIG. 3, Google's first ad would appear in the first ad position; Overture's first ad would appear in the second ad position and Overture's second ad would appear in the third ad position. In this way, the most productive ads are shown to the end user.

The issue gets more complicated when considering multiple keyword matches for a specific content page. Under such a scenario, the Relevance Score for each keyword and the CPC or CPM of each keyword are considered. The algorithm is adjusted over time and may vary from one distribution partner to another dependent on user behavior and partner desires. The example in FIG. 3 shows how this works. The most relevant word on the page is “baseball” with a relevance score of (90) and a maximum CPC of $0.57. “Giants”, the second most relevant word on the page with a relevance score of (82), has a maximum CPC value of $0.90. The system recognizes that Giants' Relevance Score is 9% less that of Baseball but the maximum value of a click from the word Giants is 58% greater that the maximum value of a click from the word Baseball. Given this, the system is programmed to show the $0.90 CPC advertisement for Giants ahead of the $0.57 CPC advertisement for Baseball. Dependent on weighting given to the relevance score, the system may be programmed to select the $1.10 World Series ad ahead of that of the others.

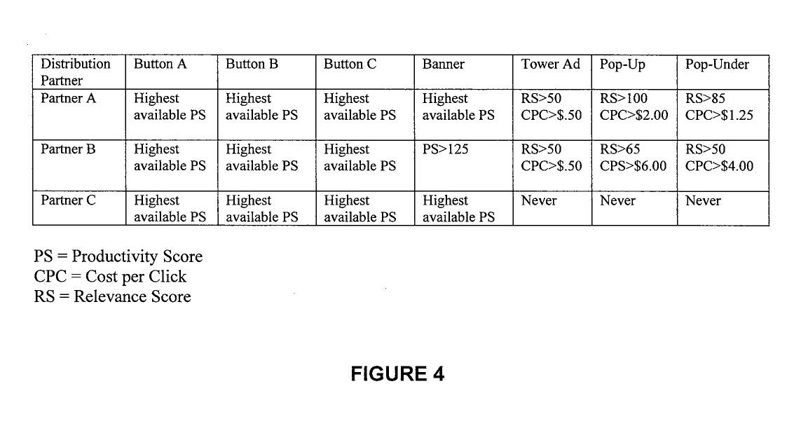

After selecting the most productive advertisements to deliver, the system determines, based on rules set by the distribution partners, the ad type to serve. These ad types vary based on partner requirements, keyword relevance and keyword value. FIG. 4 shows the flexibility of the system and the value of the model. Partner C determines that the system will serve a banner and three buttons. The section of the ads will be based on the highest available productivity score. Partner A differs from Partner C in that Partner A will include more intrusive ads when both the relevance scores and ad values are high. For example, when the Relevance Score exceeds 100 and the CPC exceeds $2.00, Partner A's users will receive a pop-up. Using this technology, distribution partners can limit the use of invasive advertising to when there is a high degree of relevance for a high value keyword, minimizing user backlash and maximizing revenue.

Using Categories

In addition to identifying the most relevant keyword(s) on a Web page, the system can be configured to identify a relevant category of the Web page and can make advertising decisions based on that category. For example, in addition to identifying a page as being about “wireless phones”, we also identify it as being about “electronics.” In this way, an “electronics” retailer can choose to have their ads only served on pages about “electronics” and a “sports” retailer could limit the display of their ads to pages about “sports”. Category relationships are assembled in a table by starting with a list of categories such as used in telephone directory yellow pages, and then listing for each category the common words or phrases that belong in that category. Then, if the user has entered the word or phrase, the associated category will be invoked. Alternatively, if a word or phrase that appears in a highly relevant location in a document being served is listed in the table, the associated concept can be used to select ads to be placed.

Optimization of the Advertising Marketplace

The invention can be used to provide a real-time marketplace for improving the relevance of advertisements and optimizing the revenue of those advertisements to a publisher. The placement of advertising in various forms of media (television, radio, and print in addition to Web placement) can be improved through the use of the techniques described herein. Those skilled in the art will be able to apply the techniques to various media in view of the description provided herein.

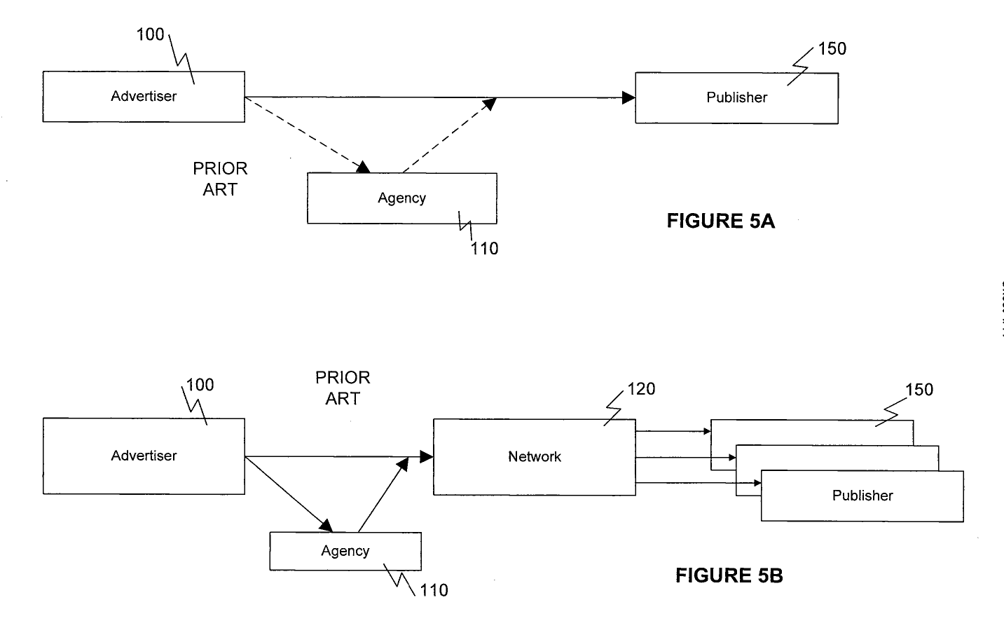

The existing conventional advertising placement process is depicted in FIG. 5A and FIG. 5B. Those skilled in the art will understand that multiple variants of this general depicted process exist, depending on the number of companies involved, but all are quite similar to the process depicted in FIG. 5A and FIG. 5B. In FIG. 5A, an advertiser 100 contacts a publisher 150 either directly (indicated by the solid line) or via an advertising agency 110 (indicated by the dotted line). As a result of the communications, advertising is placed by the publisher 150 on behalf of the advertiser 100. The process depicted in FIG. 5A is approximately the process conventionally used for placement of television, radio, print, and the majority of online advertisements.

FIG. 5B is a slightly more complex process than FIG. 5A. In the FIG. 5B process, the advertiser 100 contacts an advertising network 120 directly or via an advertising agency 110. The advertising network 120 represents numerous publishers 150. As a result, advertisements are placed by one or more of those publishers on behalf of the advertiser 100. This process is popular in the online environment and is growing in popularity in television, radio, and print media. It should be noted that neither FIG. 5A nor FIG. 5B includes a programming module such as an advertising marketplace optimizer to facilitate placement of supplemental content.

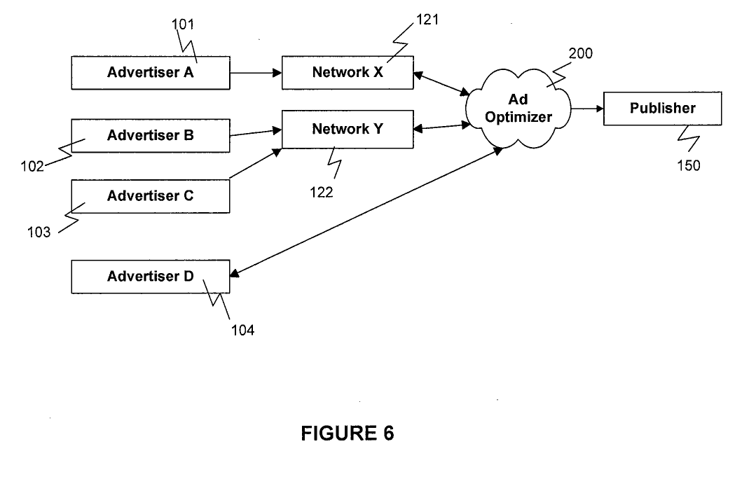

FIG. 6 displays the advertising process according to the techniques disclosed herein, which includes an advertising marketplace optimizer 200 (also referred to herein as the “ad optimizer”). Generally, advertisers have three options in participating in the process depicted in FIG. 6. An advertiser 101 (such as Advertiser A) of FIG. 6 can work with an advertising network 121 (Network X). Advertising networks typically have working relationships with numerous advertisers, and this is shown in FIG. 6 by the second advertising network 122 (Network Y) working with multiple advertisers 102, 103. In all three scenarios, the advertisers can work through the Ad Optimizer 200 with a publisher 150 to place an ad. In another scenario of FIG. 6, an advertiser 104 can work through the ad optimizer with the publisher 150. Thus, in all scenarios of FIG. 6, the supplemental content of the advertisers 101, 102, 103, 104 is placed through the ad optimizer 200 to the publisher 150.

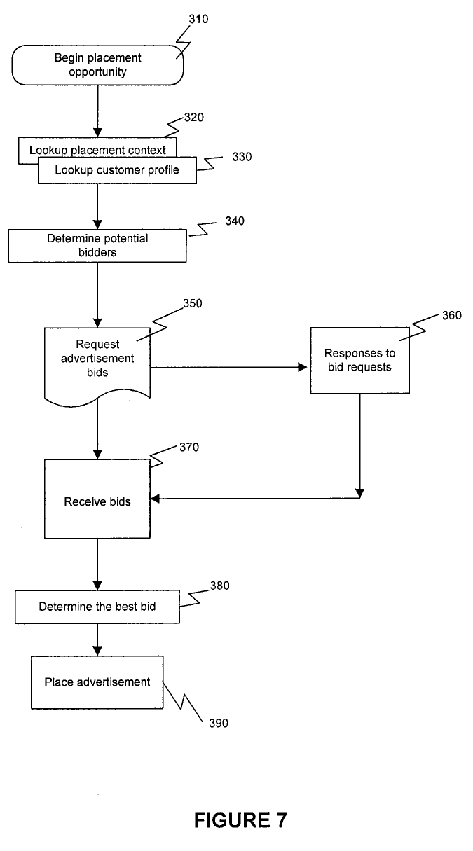

The operations to place an advertisement or other supplemental content in accordance with the invention are illustrated in FIG. 7. The illustrated operations are performed by a computer system constructed in accordance with the present invention, communicating over a network and operating through the ad optimizer 200. The system operations begin with a placement opportunity, such as represented by the box 310, indicating the start of processing for the computer system constructed in accordance with the present invention. At box 320, the context of the placement opportunity being processed is determined. The placement context can be predetermined by the publisher 150, or can be dynamically determined by data analysis of the content with which the supplemental content will be placed or can be determined, for online advertising, by data analysis of the click stream required to reach the current content. For example, the context may be determined by a category assignment for each Web page or group of pages. The context may be a function of keyword relevance.

The information concerning the placement context is received by the ad optimizer 200. In the processing of box 330, the customer profile for which the advertisement will be shown is determined. The customer profile is useful for behavioral targeting of individuals or groups of individuals, for personalization. The customer profile might provide customer segmentation to assist in such personalization. Such individual or group-focused granularity is readily possible in the online environment, but is not typically possible for media such as television, radio, and print. In such media, the customer profile is essentially replaced with information relating to target demographics and the like at the larger group level. Thus, the customer profile is useful for behavioral targeting or more simply for frequency capping (i.e. showing a specific ad to a customer no more than a specific number of times in a specific period of time). The operations of box 320 and 330 can occur in either order or simultaneously.

In box 340, a list of bidders is constructed by the ad optimizer 200. If the collection of potential bidders from FIG. 6 is utilized, then the collection of potential bidders includes the Network X 121 and Network Y 122, which includes Advertiser A 101 through Advertiser C 103, and also Advertiser D 104. Each of these potential bidders is associated with a bidder profile that can be used by the ad optimizer at box 340 to determine if there is a chance of a winning bid (or any bid) being returned by the corresponding bidder. The advertisers (sources of supplemental content) who are determined to be potential bidders are provided with a bid request. For example, if a particular advertising network specializes in sports, and the advertising opportunity is related to baseball, then that particular sports advertising network should be included as involving one or more bidders. If the advertising opportunity is related to opera, then there is no need for the ad optimizer to ask the sports network for a bid. In box 350, a bid request is sent by the ad optimizer to each entity determined at 340 to be a potential advertising bidder. The bidders receive the request and process the request in box 360, as described further below.

The bids are received and collected by the ad optimizer 200 in box 370. If a bidder does not respond to a request, or responds beyond a specified timeframe or deadline, the ad optimizer ignores the bid from that bidder for this placement opportunity. The ad optimizer can make a note of this transgression (not shown in the diagram) and can use this information in future opportunities during the processing of box 340. In particular, a habitually frequent offender may be deleted from the collection of potential bidders, or other appropriate action may be taken. After the received bids are processed at box 370, the “best” bid is determined in accordance with a productivity score at box 380, as described above. More particularly, the determination of the best bid at box 380 of FIG. 7 can be performed by the ad optimizer in accordance with the productivity score. Finally, in box 390, the selected best bid is used to select an item of supplemental content for the placement opportunity.

The processing of box 350 and box 360, to send bid requests and receive responses to bid requests, can be performed by the ad optimizer without directly contacting the supplemental content sources. That is, the ad optimizer 200 need not contact the supplemental contact sources to process a placement opportunity. Such operation is represented in FIG. 7 by the direct connection to box 370 from both box 350 and box 360. This can be achieved by examination of the bidder profile information described previously. More particularly, as noted above, the bidder profile information can be used to determine which bidders will likely bid or have sufficient interest to submit a bid. The bidder profile information can be collected and configured such that sufficient information is present in the bidder profile to identify bidders who would bid and, in fact, to determine the essential terms of that bid. Thus, the ad optimizer can receive information about a supplemental content placement opportunity and can (a) identify supplemental content sources who would be likely bidders, (b) determine the essential terms of such bids, and (c) select a winning bid for placement of the ad with a publisher. It should be appreciated that, in the context of Internet ad placement for Web pages, such processing can occur in fractions of a second. In this way, the bidder profile incorporate authorization (either implicit or explicit, depending on system configuration) for the ad optimizer to identify winning bids and make decisions about placement of supplemental content that obligate the supplemental content sources, all without direct contact following identification of the placement opportunity. This allows for quick decision making and responsiveness without increased network traffic and processing overhead.

It is possible that an advertising bidder has pre-negotiated a business arrangement with the publisher. The details of such arrangements can be encoded in the form of “business rules” that are processed in connection with box 340 and/or box 370 of FIG. 7. These business rules can be applied to force a selection, that is, to force a productivity score that results in selection of the supplemental content in conjunction with the business rules. For example, a percentage of advertising opportunities may be pre-sold to a specific bidder, and in box 340 and 350 processing, matching opportunities are sent only to that bidder. Another potential arrangement is a “floor price”, wherein a publisher agrees to place any ad from a bidder that meets or exceeds a specified price. At box 370, such an arrangement can be used to match bids to such a rule, skipping any other factors or productivity score considerations that would otherwise determine the “best” bid. Thus, so long as the bidder with the floor price agreement offers an ad at or above the floor price, that bid is guaranteed to be accepted as the “best” bid and will be placed by the publisher. Other arrangements may be implemented. For example, a location specific placement might be implemented, where some bidders may want to bid only if the content will be located with a specific placement, such as top of page, or in a side frame, or at the top of a company's home page, or the like. Another requirement for a bidder might be type placement, where placement is dependent on type of advertising, such as where only paid listings from “yellow pages” directory source will be selected. Yet another arrangement might involve source placement, where a brand advertiser might choose to pay for the right of refusal to place a banner ad for particular customers. Other business rules arrangements will occur to those skilled in the art.

In an ad optimizer 200 configured for the online advertising environment, the process illustrated in FIG. 7 is best repeated for every advertising placement opportunity. In such a scenario, every request for a Web page comprises an advertising placement opportunity, a chance to provide supplemental content such as a banner ad or pop-up along with the requested Web page or other document. Thus, every request for a Web page can initiate processing as described herein such that sources of supplemental content are matched with information about the requested page and the candidate items of supplemental content (for example, in accordance with productivity score) and then a selected item of supplemental content is provided with the requested page. Those skilled in the art will appreciate that a similar process can be used to optimize placement of a television or radio advertisement in a variety of timescales, using a computer system operating as described herein. For example, the FIG. 7 process can occur on a monthly basis, a daily basis, an hourly basis, or in real-time in a few milliseconds prior to placing or displaying any advertisement or advertising content. In a similar way, for print advertisements, this process can be used to bid for placement prior to printing.

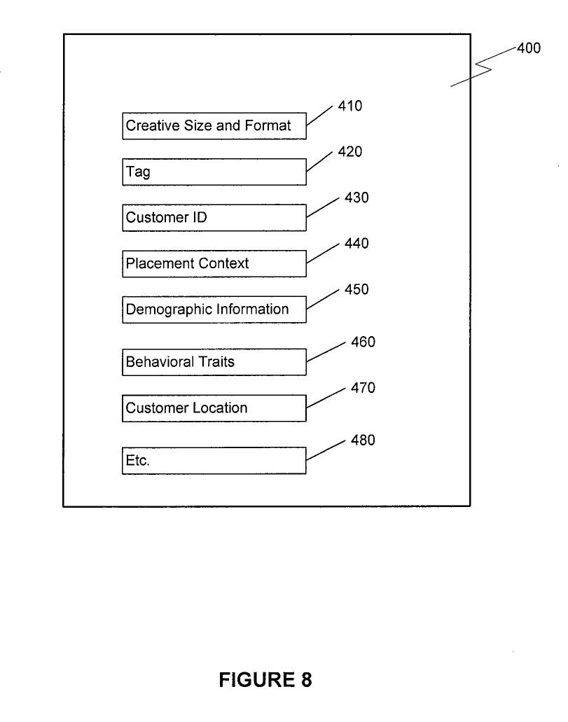

FIG. 8 illustrates the contents of a request for an advertising bid. A request 400 for advertising bid need not contain every field illustrated in FIG. 8, but should include every item needed for processing a bid request in the implemented system, in accordance with system resources and requirements. The first field 410 is for the size and format of the advertisements. Bidders may not support all sizes and formats, and thus can use this field to quickly filter out requests that cannot be filled. The next field is a tag field 420 containing a tag that summarizes the details in the remaining fields. A publisher may choose to not share all the details of the opportunity, especially the personal information of the person about to view the advertisement. Instead, the opportunities can be grouped into named entities specified by a tag. For example, all advertisement opportunities concerning sports being sent to males in the age range 18-35 could be tagged as “sports-M-18-34”. Using this tag field 420 avoids sending any customer identifier in the request for bid, but puts the onus of frequency capping and other personalized advertising parameters on the ad optimizer instead of on the bidder. If the publisher does use the other fields within the bid, then the tag 420 need not also be used.

The next field is a customer ID field 430 that contains the customer identifier (customer ID). To protect the privacy of customers, the best-practices call for this to be an obfuscated identifier, that is, not a phone number, government identification number, or other personal identifier. Ideally, the value used for the customer identifier is encoded to be different for each bidder, further obfuscating customer identities.

The fourth field is the placement context field 440 that contains the context of the placement opportunity. The placement context can be as simple as an encoding for categorization, e.g. news, sports, entertainment, or weather. Alternatively, context can be far more detailed, with a list or hierarchy of terms, e.g. sports/golf/Tiger Woods/putting/eagle. The next field 450 contains the demographic information of the customer. This information includes such data as age, gender, home city. The next field 460 of the request contains identifiers of behavioral traits of the customer. Such traits can include broad behaviors, e.g. “reads news”, or can comprise detailed information, e.g. “subscribes to The Wall Street Journal”. The next field 470 is the customer's current location and/or home location. This field can be coarse data, e.g. “United States”, or can refer to more granular data, e.g. geographic latitude/longitude, or something in between in terms of specificity, e.g. “Seattle, Wash.”. If desired, other information can be provided in other fields 480 of the bid request, such as previously accepted bid values from the bidder or the expected winning bid value.

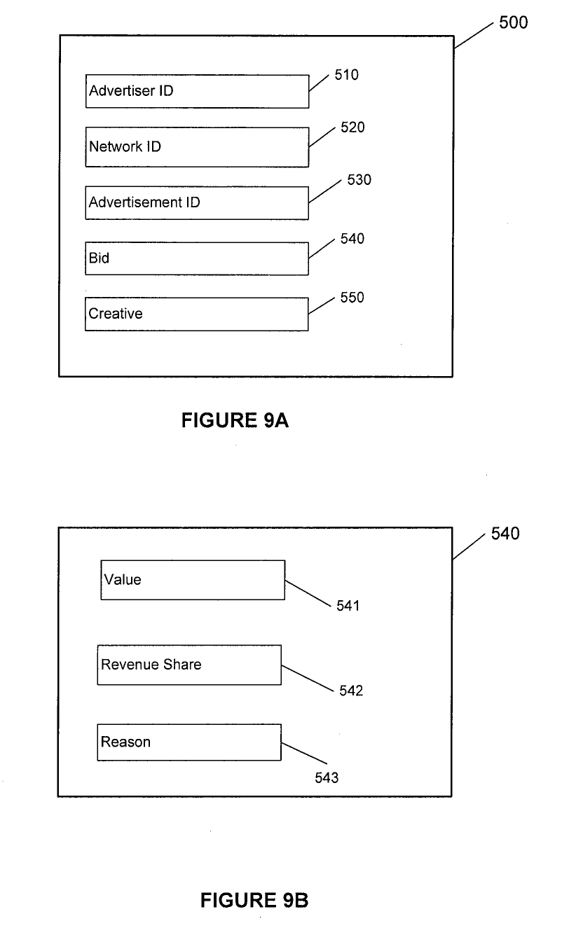

A bid response is illustrated in FIG. 9A. A bid response 500 need not contain every field illustrated in FIG. 9A, but should include every item needed for processing a bid response in the implemented system, in accordance with system resources and requirements. In FIG. 9A, the first field is an advertiser field 510 that contains an identifier of the advertiser. The network field 520 contains an identifier of the network (or for direct advertisers, this is not necessary). The advertisement ID field 530 contains an identifier of the advertisement and/or advertising campaign. This field allows the ad optimizer to track a single advertising campaign across different placement sizes and formats. The next field is a bid field 540 that contains the bid response by the advertiser. The ad optimizer can be configured to accept bids as monetary values or some other measure of value generally convertible to a monetary value. An example of the latter is a system wherein advertisers/networks pre-pay for tokens, which are used during the bidding process. More details on the bid field 540 are provided in connection with FIG. 5B, described below. The next field in the bid response of FIG. 9A is the creative field 550. The creative field 550 contains the “creative” in the format and size specified in the bid request 400. It should be noted that creatives may comprise very large data files, and thus scaling the operation of the ad optimizer to hundreds or thousands of advertisers and networks can be hampered by this field. In best practices, the creative field 550 can contain simply a reference or pointer to the creative, which can be downloaded from the winning bidder (see box 380 of FIG. 7).

FIG. 9B shows optional detail on the values passed to the ad optimizer in the bid field 540. The bid field 540 in the bid response 500 need not be a simple currency value. In general, placement of advertising requires far more detail in the bid field, and FIG. 9B displays some of the subfields that may be included in the bid field 540. The value subfield 541 provides information relating to the value of the bid response. As described above, this can be in currency or other convertible units. The share subfield 542 contains information relating to the revenue share used by the bidder. In many cases, the bidder is an advertising network, representing an advertiser and responsible for the accounts receivable of advertisement placements. When an advertisement is placed via the online marketplace described herein, the advertising network shares in the placement cost with the marketplace. This can either be specified by a “net” price in the value subfield 541, or that subfield can contain the “gross” price with a review split (also referred to as “gross margin”) specified in the share subfield 542. Having the gross price allows the marketplace to optimize placement based on the true cost to the advertiser and provides more transparency to the publisher. An advertising network may not want to share the gross price information, and thus the gross margin field is optional. The next field is a reason subfield 543 that holds encoding data by the bidder as to what fields in the bid request were important in generating the response. This information is useful to the marketplace in choosing the best subset of bidders to make requests for each advertising opportunity (for example, see box 340 of FIG. 7), and in optimizing the information required for each bidder. For example, if a bidder always responds with a reason subfield 543 specifying that only the location was used to generate the bid, then the ad optimizer need only send the location field to that bidder in future bid requests. In the same example, if the location is not available as a data item, then that particular bidder can be skipped in the collection of bidders, as the marketplace can determine that the bidder will be unable to bid without that request field (which, for that bidder, is apparently of paramount importance). Bidders may not want to share this information and thus this field is also optional.

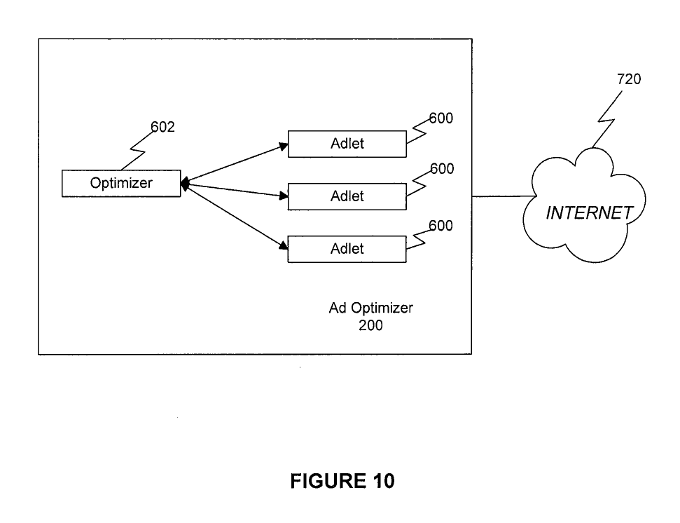

In order to scale to large numbers of advertisers/networks and placement opportunities, the system minimizes the overhead required to request the bids and process the responses. The distributed configuration for the ad optimizer, comprising an “Optimizer” module and an “Adlet” module, provides a system architecture to optimize this processing. As illustrated in FIG. 10, the ad optimizer 200 is configured as a set of Adlets 600 operating in conjunction with an Optimizer 602. This configuration permits distribution of the processing and can contribute to reduced network traffic and overhead. In the distributed configuration of the ad optimizer 200 shown in FIG. 10, the received bids are provided directly to one of the Adlets, or alternatively, the Optimizer 602 calls one or more Adlets 600 for carrying out processing on the received bids.

Thus, the Adlet 600 generates the bid responses, while the Optimizer 602 picks from among the bid responses. In this way, the Adlet comprises a programming module or programmatic agent that represents an ad network or an advertiser. The best bid is not necessarily the highest bid, but determining the best bid may take into account the customer profile, the bidder profile, business rules, or other factors that can influence the productivity of an ad placement. For example, an ad that generates $0.20 per click that has a 4.0% click rate will likely be selected over an ad that generates $0.50 per click that has a 0.5% click rate.

In the FIG. 10 distributed configuration of the ad optimizer, the processing operations for bid request and processing are divided between the Adlets 600 and the Optimizer 602. Thus, the Adlet is a programmatic representative of the bidders (supplemental content sources), and the Optimizer is a programmatic agent for selection of supplemental content. As such, the Optimizer identifies Adlets to which bid requests will be sent, and selects from among the bids provided by the Adlets to select a winning bid. Thus, for this embodiment with respect to FIG. 7, the Optimizer 602 performs the operations of box 350, while the Adlets 600 perform the operations of box 360. For the Adlets to provide bids, the Adlets may generate the productivity score information described above relating to the supplemental content sources. The Optimizer can make the selection of winning bids in accordance with the business rules mentioned above (see description above in connection with box 340 and box 370 of FIG. 7). For example, the Optimizer 602 might select according to an arrangement in which a percentage of advertising opportunities are pre-sold to a specific bidder, and therefore might send requests for bids to Adlets in connection with placement opportunities only for corresponding bidders. Other business rules processing, such as the “floor price” arrangement, or a location specific placement, type placement, or source placement, may be implemented by the Optimizer.

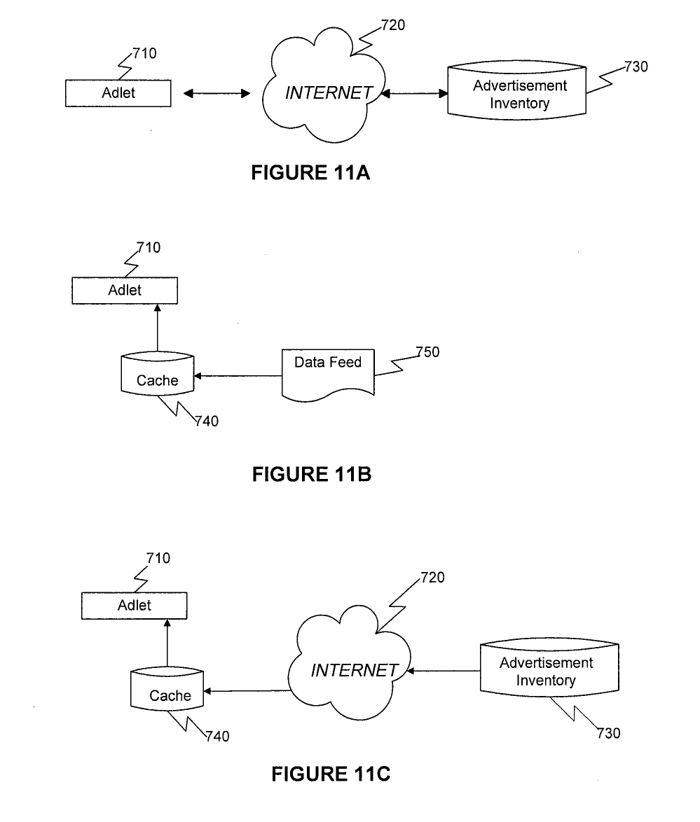

The connecting arrows between the Adlets 600 and Optimizer 602 illustrated in FIG. 10 indicate that each Adlet 600 is a computer process that communicates with the Optimizer. The Adlets 600 are either co-located with the Optimizer 602, meaning they are operating at the same host computer or at a nearby node of the same local area network (LAN) as the Optimizer, without requiring the bid requests to cross the extended computer network 720 (i.e., the Internet) for the bid requests to be exchanged between the Adlets and the Optimizer. If desired, some Adlets 600 can be co-located with the Optimizer 602, and others may be located elsewhere across the extended network. It is likely that many bids will be forwarded across the Internet (see FIGS. 11A, 11B, and 11C), but the invention of an Adlet 600 allows as much bidding as possible to be as local to the Optimizer 602 as possible. This reduces network traffic and associated overhead. The Adlets 600 are responsible for selecting advertising content, or other supplemental content, for inclusion with requested documents such as Web pages. The Adlets may comprise programmatic agents that utilize information related to advertising opportunities, generate advertising bids, receive bid responses, and select supplemental content (i.e., advertising) for inclusion with requested documents. Together, the Adlets 600 and Optimizer 602 perform the processing of the ad optimizer 200 described above.

Three forms of Adlets are illustrated in FIGS. 11A, 11B, and 11C. Those skilled in the art will understand that other designs are possible. In all cases, the illustrated Adlet comprises a computer process that receives requests for advertising bids and returns bid responses. Thus, as noted above, the Adlet comprises a programming module or programmatic agent that represents an ad network or an advertiser.

FIG. 11A shows an Adlet 710 that simply forwards bid requests across the Internet 720 to a system 730 that holds the available supplemental content inventory. The system 730 includes processes for receiving the bid requests and processing them, to return a bid response to the forwarding Adlet. In this way, the Adlet 710 may carry out bid processing without directly contacting the sources of supplemental content, as noted above for processing by the ad optimizer (see description for processing of box 360 of FIG. 7). That is, the Adlet will respond to a request for bid by generating a bid, based on bidder profile information, and the Adlet will determine the bid parameters (including content) by communicating with the inventory of supplemental content 730.

The Adlet 710 as illustrated in FIG. 11A need not forward every request for bid to the inventory system 730, as the Adlet 710 can locally filter requests for unsupported formats, contexts, demographics, and the like, that are certain to not match any advertising in the inventory 730. That is, the Adlet 710 of FIG. 11A can receive many bid requests from the Optimizer 602, but will be able to locally filter the requests so that bid requests are only processed against relevant or viable advertisement inventory and are sent only to relevant or viable bidders. Each bid request that is processed, however, involves access to the advertising inventory 730 across the network 720.

FIG. 11B shows another Adlet 710 that permits all the bid processing to be performed locally. An advertising inventory cache 740 is generated via a data feed 750. The data feed may be provided to the advertising marketplace optimization company (represented by the Optimizer) on computer program media such as a disk, on an advertiser Web site for download, on paper for input, or dictated over the phone for input. The advertisement cache 740 of FIG. 11B represents an inventory of advertising material and is analogous to the system advertisement inventory 730 illustrated in FIG. 11A, except that the inventory is local. Thus, bid processing is carried out locally such that the host computer at which the Adlet 710 operates or executes is also the host computer to which the cache 740 is stored or attached directly or via LAN and carries out bid processing so that communications over the extended network (Internet) are not necessary to access the cache and provide a bid response.

FIG. 11C illustrates a hybrid design that includes a local cache and network inventory. The Adlet 710 of FIG. 11C communicates with a local system having a local advertisement inventory cache 740, so that bid request processing is carried out locally in a fashion similar to the operation of FIG. 11B. In FIG. 11C, however, the local cache system 740 is updated periodically via the Internet 720 from the complete advertising inventory 730. If desired, the local cache system 740 can include management programming that automatically checks the Internet inventory 730 at predetermined times or in response to requests or notifications, such that communications over the extended network 720 are not necessary to process each bid request, but the local cache system 740 can be consulted with greater confidence that it is updated. The hybrid implementation of FIG. 11C helps reduce network overhead and message traffic in processing advertising opportunities and requests. As noted above, each of the Adlets 710 may include filtering processes through which the Adlet receives information for generating requests for bids and filters the information according to recipient data to generate a reduced umber of requests for bids that are more likely to provoke a responsive bid from the advertisement inventory. In each case, the advertisement inventory may include supplemental content (e.g., advertising) from multiple sources (e.g., advertisers).

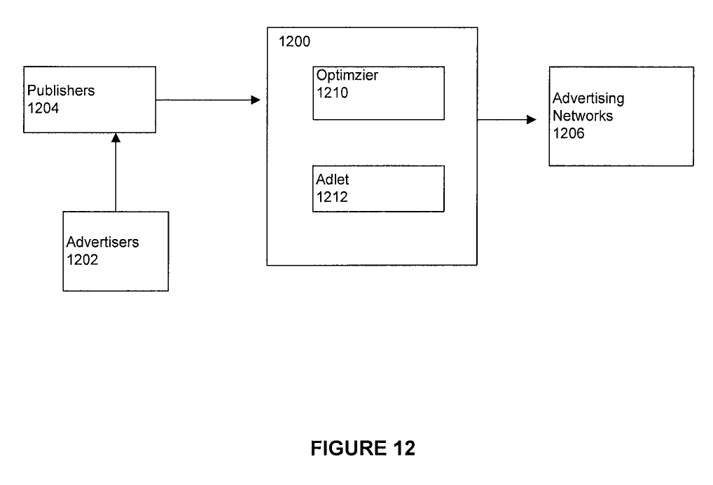

FIG. 12 is a block diagram of a computer system constructed in accordance with the invention. The computer system 1200 is constructed as a conventional computer processor such as a typical desktop or laptop computer with a network communications module that enables communication over a network, such as a Local Area Network (LAN), the Internet, and the like. The system 1200 includes a display device, a keyboard, internal memory for program instructions, non-volatile storage, a display pointing device such as a mouse, and optional ancillary devices and drives for data storage. If desired, the system 1200 can be used to serve the documents that are selected in accordance with this description.

Advertisers 1202, such as advertisers who want to place advertising in media, work with publishers 1204 who are responsible for providing content to the public. The publishers 1204 can comprise, for example, print, broadcast, radio, and Internet media. The publishers, in turn, communicate with the computer system 1200 to receive requests for advertising bids and to respond with bids for keywords, advertising placement, and the like, as described previously. The system communicates with advertising networks 1206 to retrieve selected ads for inclusion with requested content. The system 1200 will typically request the advertising content from the advertising networks 1206 and will provide the selected content to Web servers. The Web servers will then serve the requested Web pages (document content) and will also serve the selected advertising. Alternatively, the system 1200 can instruct the advertising networks 1206 to provide the selected advertising content directly to the Web servers. If desired, the system 1200 can operate as an advertising server. That is, not only can the system determine which ads should be placed with requested documents, the system can also serve the requested ads via its network communications interface. In that configuration, the system will typically include sufficient data storage to contain a suitable amount of advertising content for placement with requested documents. If desired, the system can also operate as a Web server, providing the requested documents as well as the selected advertising content.

The system 1200 includes the Optimizer 1210 and Adlets 1212 described previously. The Optimizer is responsible for communications with the publishers, ad networks, and others who use the services of the system, and for generating requests for bids. The Adlets are responsible for providing bids and for selecting advertising content, or other supplemental content, for inclusion with requested documents such as Web pages. The Adlets may comprise programmatic agents such as program modules that are compiled and then are executed (called) by the Optimizer, or the Adlets may comprise programming scripts or interpreted applets. Adlet programs may be written in a programming language, for example, such as C, C++, Java, Visual Basic or other suitable programming language. Adlet scripts may be written in Javascript, VBScript, html script, or other suitable scripting languages or applets.

Although the documents have been described in terms of requested Web pages and the supplemental content has been described in terms of advertising, it should be understood that the requested documents can comprise a wide range of documents requested by computer network communications, such as multimedia content, stored document data files, and the like. Similarly, the supplemental content can comprise a wide variety of material to be published or viewed or rendered along with the requested document, such as auxiliary materials, complementary materials of a different medium, video, sound, or other media.

The operations described above can be performed on a wide variety of computer devices having programmable processors. The processing described herein can be implemented at such computer devices through a computer program product comprising a machine readable storage device containing programming instructions for execution by a programmable processor to perform a method of selecting content for display at a client computer communicating over a computer network, wherein the programming instructions comprise instructions to perform the described operations.

Thus, described herein are techniques for optimizing and evaluating a collection of supplemental content to determine the best content to choose, such as choosing from among different advertisements, based on a productivity score of the advertisement. Determining the “best” ad to be placed (and determining which source should receive a request for bid) is performed by considering the context of the ad placement opportunity and by performing such decision making with an ad optimizer that may include a distributed configuration have an Adlet. The Adlet receives information about an advertising placement opportunity, such as in the form of a booking request or a database check that reveals unbooked time, so that the Adlet identifies a spot or location that is available for ad placement. The Adlet responds to this opportunity by generating requests for ad bids. The responses are evaluated and the supplemental content (advertising) to be delivered with the requested content is selected.

Having fully described several embodiments of the present invention, other equivalent or alternative methods of practicing the present invention will be apparent to those skilled in the art. These and other embodiments as well as alternatives and equivalents to the described system will be recognizable to those of skill in the art after reading the description herein. The scope of the invention should not, therefore, be determined solely by reference to the above description, but instead should be determined with reference to the appended claims along with their full scope of equivalents and alternatives.

We claim:

1. A method for selecting content for display at a client computer communicating over a computer network, the method comprising:
(a) determining a relevance score for content of a document at a server computer for delivery to a requesting client computer;
(b) determining at least one valuation for the content from each of two or more supplemental content sources;
(c) generating a productivity score for each of the supplemental content sources in accordance with the corresponding content valuation for the supplemental content source;
(d) selecting the supplemental content source having the greatest productivity score;
(e) serving the document and supplemental content from the selected supplemental content source for delivery to the requesting client computer.

2. The method of claim 1, wherein the document comprises a Web page.

3. The method of claim 2, wherein document content comprises keywords of the Web page.

4. The method of claim 2, wherein the valuation comprises keyword bid values from the supplemental content sources.

5. The method of claim 4, wherein the bid values are received from the supplemental content sources in response to a request for bids issued after a request for the Web page from the requesting client computer.

6. The method of claim 2, wherein the supplemental content from the selected supplemental content source comprises advertising content for delivery with the Web page.

7. The method of claim 1, wherein the supplemental content sources comprise sources of Web advertising content.

8. The method of claim 1, wherein selecting the supplemental content source comprises constructing a decision matrix relating to the supplemental content sources and their associated productivity scores.

9. The method of claim 1, wherein selecting the supplemental content source further comprises selecting an advertising type in accordance with the productivity score.

10. The method of claim 1, wherein selecting the supplemental content source further comprises selecting an advertising type in accordance with the relevance score.

11. The method of claim 1, wherein selecting the supplemental content source further comprises selecting an advertising type in accordance with a cost per click value associated with the productivity score.

12. The method of claim 1, wherein the supplemental content source comprises an advertisement inventory.

13. The method of claim 12, wherein the advertisement inventory is stored locally to the server computer.

14. The method of claim 12, wherein the advertisement inventory is accessed through network communications.

15. The method of claim 1, wherein selecting the supplemental content source comprises selecting in accordance with a business rules parameter.

16. The method of claim 15, wherein the business rules parameter comprises a floor price arrangement.

17. The method of claim 1, wherein generating a productivity score is performed by an ad optimizer computer process.

18. The method of claim 17, wherein the ad optimizer computer process operates at the server computer.

19. The method of claim 17, wherein the ad optimizer computer process comprises an Optimizer programmatic agent that generates a request for bid and an Adlet programmatic agent that receives the request for bid and provides a responsive bid relating to at least one supplemental content source.

20. The method of claim 19, wherein the Optimizer programmatic agent receives information for generating a plurality of requests for bids and filters the information according to recipient data to generate a reduced number of requests for bids that are more likely to provoke a responsive bid from the supplemental content source.

21. The method of claim 19, wherein the Optimizer programmatic agent determines the reduced number of requests for bids in accordance with a business rules parameter to identify supplemental content sources that will be the objects of the requests for bids.

22. The method of claim 21, wherein the business rules parameter comprises a floor price arrangement.

23. The method of claim 21, wherein the business rules parameter comprises a location specific arrangement.

24. The method of claim 21, wherein the business rules parameter comprises a type arrangement.

25. The method of claim 21, wherein the business rules parameter comprises a source arrangement.

26. A method of selecting content for display at a client computer communicating over a computer network, the method comprising:
identifying a supplemental content opportunity wherein supplemental content will be served along with a requested document;
generating a request for content bid to an inventory of supplemental content through an ad optimizer computer process;
receiving a bid response relating to the supplemental content at the ad optimizer computer process in response to the request for content bid;
selecting a bid response at the ad optimizer computer process and determining supplemental content for delivery with the requested document.

27. The method of claim 26, further including:
determining a relevance score for content of the requested document at a server computer for delivery to the requesting client computer, determining at least one valuation for the content from each of two or more supplemental content sources, generating a productivity score for each of the supplemental content sources in accordance with the corresponding content valuation for the supplemental content source;
wherein selecting a bid response at the ad optimizer computer process comprises selecting the supplemental content source in accordance with the productivity score.

28. The method of claim 27, wherein the ad optimizer computer process operates at the server computer.

29. The method of claim 27, wherein the ad optimizer computer process comprises an Optimizer programmatic agent that generates a request for bid and an Adlet programmatic agent that receives the request for bid and provides a responsive bid relating to at least one supplemental content source.

30. The method of claim 29, wherein the Optimizer programmatic agent receives information for generating a plurality of requests for bids and filters the information according to recipient data to generate a reduced number of requests for bids that are more likely to provoke a responsive bid from the supplemental content source.

31. The method of claim 29, wherein the Optimizer programmatic agent determines the reduced number of requests for bids in accordance with a business rules parameter to identify supplemental content sources that will be the objects of the requests for bids.

32. The method of claim 31, wherein the business rules parameter comprises a floor price arrangement.

33. The method of claim 31, wherein the business rules parameter comprises a location specific arrangement.

34. The method of claim 31, wherein the business rules parameter comprises a type arrangement.

35. The method of claim 31, wherein the business rules parameter comprises a source arrangement.

36. A computer system that selects content for display at a client computer communicating over a computer network with the computer system, the computer system comprising:
an Optimizer programmatic agent that identifies a supplemental content opportunity wherein supplemental content will be served along with a requested document and generates a request for content bid to an inventory of supplemental content and receives;
an Adlet programmatic agent that provides at least one bid response to the request for content bid, wherein the Optimizer selects a bid response and determines supplemental content for delivery with the requested document.

37. The computer system as in claim 36, wherein:
the Optimizer programmatic agent determines a relevance score for content of the requested document at a server computer for delivery to the requesting client computer, and determines at least one valuation for the content from each of two or more supplemental content sources; and
the Adlet programmatic agent generates a productivity score for each of the supplemental content sources in accordance with the corresponding content valuation for the supplemental content source, wherein the Optimizer programmatic agent selects a bid response for delivery of the corresponding supplemental content.

38. The system of claim 37, further including a server computer from which the requested document is served, and wherein the Adlet computer process operates at the server computer.

39. The system of claim 37, wherein the Optimizer programmatic agent generates a request for bid and the Adlet programmatic agent receives the request for bid and provides a responsive bid relating to at least one supplemental content source.

40. The system of claim 39, wherein the Optimizer programmatic agent receives information for generating a plurality of requests for bids and filters the information according to recipient data to generate a reduced number of requests for bids that are more likely to provoke a responsive bid from the supplemental content source.

41. The system of claim 40, wherein the Optimizer programmatic agent determines the reduced number of requests for bids in accordance with a business rules parameter to identify supplemental content sources that will be the objects of the requests for bids.

42. The system of claim 41, wherein the business rules parameter comprises a floor price arrangement.

43. The system of claim 41, wherein the business rules parameter comprises a location specific arrangement.

44. The system of claim 41, wherein the business rules parameter comprises a type arrangement.

45. The system of claim 41, wherein the business rules parameter comprises a source arrangement.

46. A computer system for selecting supplemental content for display at a client computer communicating over a computer network with the computer system, the computer system comprising:
Optimizer means for identifying a supplemental content opportunity wherein supplemental content will be served along with a requested document and generating a request for content bid to an inventory of supplemental content;
Adlet means for providing a bid response in response to the request for content bid and selects a bid response at the Adlet computer process and determines supplemental content for delivery with the requested document;
delivery means for serving the document from a server computer and serving supplemental content from the selected supplemental content source for delivery to the requesting client computer.

47. The computer system of claim 46, wherein the Adlet means selects the supplemental content by selecting the supplemental content source having the greatest productivity score.

48. The computer system of claim 46, wherein the Optimizer means comprises a computer process that operates at the server computer.

49. The system of claim 48, wherein the Optimizer means comprises a programmatic agent that generates a request for bid and provides the request for bid to the Adlet means, which provides a responsive bid relating to at least one supplemental content source.

50. The system of claim 48, wherein the Optimizer means comprises a programmatic agent that receives information for generating a plurality of requests for bids and filters the information according to recipient data to generate a reduced number of requests for bids that are more likely to provoke a responsive bid from the supplemental content source.

51. The system of claim 48, wherein the Optimizer means comprises a programmatic agent that determines the reduced number of requests for bids in accordance with a business rules parameter to identify supplemental content sources that will be the objects of the requests for bids.

52. The system of claim 51, wherein the business rules parameter comprises a floor price arrangement.

53. The system of claim 51, wherein the business rules parameter comprises a location specific arrangement.

54. The system of claim 51, wherein the business rules parameter comprises a type arrangement.

55. The system of claim 51, wherein the business rules parameter comprises a source arrangement.

56. A computer program product comprising a machine readable storage device containing programming instructions for execution by a computer having a programmable processor to perform a method of selecting content for display at a client computer communicating over a computer network, the programming instructions comprising instructions for:
identifying a supplemental content opportunity wherein supplemental content will be served along with a requested document;
generating a request for content bid to an inventory of supplemental content through an ad optimizer computer process;
receiving a bid response relating to the supplemental content at the ad optimizer computer process in response to the request for content bid;
selecting a bid response at the ad optimizer computer process and determining supplemental content for delivery with the requested document.

57. The computer program product of claim 56, the programming instructions further including instructions for:
determining a relevance score for content of the requested document at a server computer for delivery to the requesting client computer, determining at least one valuation for the content from each of two or more supplemental content sources, generating a productivity score for each of the supplemental content sources in accordance with the corresponding content valuation for the supplemental content source;
wherein selecting a bid response at the ad optimizer computer process comprises selecting the supplemental content source in accordance with the productivity score.

58. The computer program product of claim 57, wherein the ad optimizer computer process operates at a server computer.

59. The computer program product of claim 57, wherein the ad optimizer computer process comprises an Optimizer programmatic agent that generates a request for bid and an Adlet programmatic agent that receives the request for bid and provides a responsive bid relating to at least one supplemental content source.

60. The computer program product of claim 59, wherein the Optimizer programmatic agent receives information for generating a plurality of requests for bids and filters the information according to recipient data to generate a reduced number of requests for bids that are more likely to provoke a responsive bid from the supplemental content source.

61. The computer program product of claim 59, wherein the Optimizer programmatic agent determines the reduced number of requests for bids in accordance with a business rules parameter to identify supplemental content sources that will be the objects of the requests for bids.

62. The computer program product of claim 61, wherein the business rules parameter comprises a floor price arrangement.

63. The computer program product of claim 61, wherein the business rules parameter comprises a location specific arrangement.

64. The computer program product of claim 61, wherein the business rules parameter comprises a type arrangement.

65. The computer program product of claim 61, wherein the business rules parameter comprises a source arrangement.
